(19) United States
(12) Patent Application Publication
(10) Pub. No.: US 2013/0187877 A1
(43) Pub. Date: Jul. 25, 2013

(54) DISPLAY DEVICE

(71) Applicants: Masahiro TADA, Tokyo (JP); Takashi Nakamura, Saitama-shi (JP); Hirotaka Hayashi, Fukaya-shi (JP); Masayoshi Fuchi, Ageo-shi (JP); Yasuo Saruhashi, Fukaya-shi (JP)

(72) Inventors: Masahiro TADA, Tokyo (JP); Takashi Nakamura, Saitama-shi (JP); Hirotaka Hayashi, Fukaya-shi (JP); Masayoshi Fuchi, Ageo-shi (JP); Yasuo Saruhashi, Fukaya-shi (JP)

(21) Appl. No.: 13/724,119

(22) Filed: Dec. 21, 2012

(30) Foreign Application Priority Data
Jan. 19, 2012 (JP) 2012-008883

(51) Int. Cl. G06F 3/041

(52) U.S. Cl. CPC G06F 3/0416
USPC 345/173

(57) ABSTRACT

According to one embodiment, a display device includes a plurality of pixel circuits which are arranged in a matrix, a plurality of sensor circuits which are arranged in regions between the pixel circuits and which read the magnitude of capacitance coupling, a plurality of scanning lines for the pixel circuits and sensor circuits, a plurality of signal lines for the pixel circuits and sensor circuits a part of which are shared, a controller which controls alternating-current driving that inverts, with a specific period, the polarity of a display signal written into the pixel circuits, and a determination module which determines a magnitude correlation between a sensor signal read from the sensor circuit and a polarity-based threshold value corresponding to the polarity of alternating-current driving in reading the sensor signal.

### CROSS-REFERENCE TO RELATED APPLICATIONS

This application is based upon and claims the benefit of priority from Japanese Patent Application No. 2012-008883, filed Jan. 19, 2012, the entire contents of which are incorporated herein by reference.

### FIELD

Embodiments described herein relate generally to a display device.

### BACKGROUND

An electronic device provided with a display device that has a touch panel function as a user interface, such as a mobile phone, a personal digital assistant, or a personal computer, has been developed. As for an electronic device with such a touch panel function, the idea of laminating a separate touch panel substrate to a display device, such as a liquid-crystal display device or an organic EL display device, to add a touch panel function is under consideration.

In recent years, efforts have been directed toward researching the technique for manufacturing an image reading device by forming a thin film on a transparent insulating substrate, such as a glass substrate, by chemical vapor deposition (CVD) techniques or the like using various materials and repeating cutting and grinding operations, and the like to form display elements composed of scanning lines and signal lines, optical sensor elements, and the like.

In addition, as for a reading method for the image reading device, studies have been conducted on the technique for detecting a contact position by a so-called capacitance method by arranging a conductive electrode in place of an optical sensor element or the like and detecting information on a finger or the like on the panel surface according to a variation in the capacitance between the electrode and a finger or the like.

In the field of display devices using the capacitance method, the technique for incorporating a sensor function into a display panel, such as a liquid-crystal panel, what is called in-cell technology, is being developed actively. When a touch panel function is realized by incorporating a sensor circuit for detecting a touch position in the upper part of a substrate constituting the display device, the contact position detecting accuracy might deteriorate as a result of a part of the circuit being shared by the display function and the sensor function.

For example, in an input-function-provided display device with a sensor circuit and a display circuit, the sensor circuit and display circuit share a part of the signal lines laid vertically and a sensor reading operation and a display operation are performed in a time-sharing mode. Therefore, the display signal influences the read sensor value in the form of noise (display noise), contributing to a decrease in the contact position detection accuracy.

### BRIEF DESCRIPTION OF THE DRAWINGS

FIG. 1 is a schematic exemplary plan view showing the configuration of a display device according to an embodiment;

FIG. 2 is an exemplary sectional view of the display device according to the embodiment;

FIG. 3 is an exemplary diagram showing an equivalent circuit of a sensor circuit according to the embodiment;

FIG. 4 shows an exemplary timing chart to explain a method of driving the display device according to the embodiment;

FIG. 5 is an exemplary diagram to explain the basic idea of a contact determination method in the display device according to the embodiment;

FIG. 6 is an exemplary diagram to explain points to keep in mind when the contact determination method in the display device according to the embodiment is applied to an alternating-current-driven liquid-crystal device;

FIG. 7 is an exemplary diagram to explain a contact determination method in alternating-current driving in the display device according to the embodiment;

FIG. 8 is an exemplary diagram to explain a contact determination in alternating-current driving in the display device according to the embodiment;

FIG. 9 is an exemplary block diagram showing a configuration related to a contact determination process of a control module according to the embodiment; and

FIG. 10 shows an exemplary flowchart to explain a schematic procedure for a contact presence/absence determination process according to the embodiment.

### DETAILED DESCRIPTION

In general, according to one embodiment, a display device includes a plurality of pixel circuits which are arranged in a matrix, a plurality of sensor circuits which are arranged in regions between the pixel circuits and which read the magnitude of capacitance coupling, a plurality of scanning lines for the pixel circuits and sensor circuits which are extended in a row direction in which the pixel circuits are arranged, a plurality of signal lines for the pixel circuits and sensor circuits which are extended in a column direction in which the pixel circuits are arranged and a part of which are shared, a display driver which drives a plurality of scanning lines and signal lines for the pixel circuits in a display operation period and writes a display signal into the pixel circuits on a row basis, a sensor driver which drives a plurality of scanning lines and signal lines for the sensor circuits in a sensor operation period and reads a signal representing the magnitude of the capacitance coupling from the sensor circuits on a row basis, a controller which controls alternating-current driving that inverts, with a specific period, the polarity of a display signal written into the pixel circuits, and a determination module which determines a magnitude correlation between a sensor signal read from the sensor circuit and a polarity-based threshold value corresponding to the polarity of alternating-current driving in reading the sensor signal.

Hereinafter, a display device according to an embodiment and a method of driving the display device will be explained with reference to the accompanying drawings.

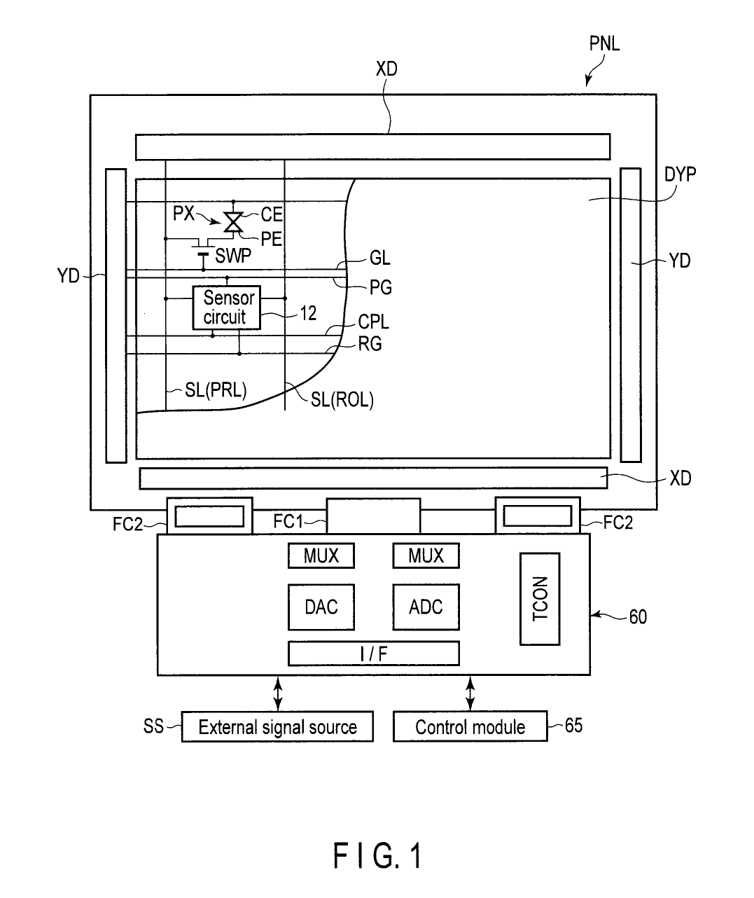

FIG. 1 is a schematic exemplary plan view showing the configuration of the display device according to the embodiment.

The display device 1 of the embodiment comprises a liquid-crystal display panel PNL and a circuit board 60. To one end of the liquid-crystal display panel PNL, one end of a flexible substrate FC1 and that of each flexible substrate FC2 are electrically connected. To the other ends of the flexible substrates FC1, FC2, the circuit board 60 is electrically connected.

The liquid-crystal display panel PNL comprises a display module DYP composed of a plurality of pixels arranged in a matrix, scanning line driving circuits YDs, and signal line driving circuits XDs, the scanning line and signal line driving circuits being arranged around the display module DYP. The circuit board 60 controls not only a display operation of the display device but also sensor circuits (described later) provided at the liquid-crystal display panel PNL. Specifically, the circuit board 60 outputs a video signal obtained from an external signal source SS to the liquid-crystal display panel PNL. In addition, the circuit board 60 not only supplies a signal to operate the sensor circuits but also outputs output signals obtained from the sensor circuits to a control module 65.

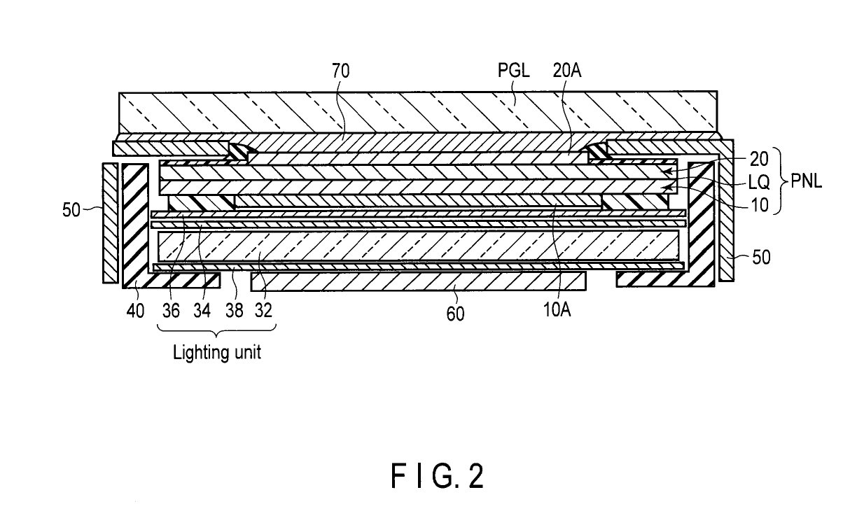

FIG. 2 is an exemplary sectional view of the display device according to the embodiment.

The display device 1 of the embodiment comprises a liquid-crystal display panel PNL, a lighting unit, a frame 40, a bezel cover 50, a circuit board 60, and a protective glass PGL.

The lighting unit is arranged on the back face side of the liquid-crystal display panel PNL. The frame 40 supports the liquid-crystal display panel PNL and the lighting unit. The bezel cover 50 is provided on the frame 40 so as to expose the display module DYP of the liquid-crystal display panel PNL. The circuit board 60 is arranged on the back face side of the frame 40. The protective glass PGL is fixed on the bezel cover 50 with an adhesive 70.

The liquid-crystal display panel PNL comprises an array substrate 10, an opposite substrate 20 arranged so as to face the array substrate 10, and a liquid-crystal layer LQ sandwiched between the array substrate 10 and the opposite substrate 20. The array substrate 10 includes a polarizing plate 10A provided on a principal surface opposite the liquid-crystal layer LQ.

The opposite substrate 20 includes a polarizing plate 20A mounted on a principal surface opposite the liquid-crystal layer LQ.

The lighting unit includes a light source (not shown), a light guiding unit 32, a prism sheet 34, a diffusion sheet 36, and a reflection sheet 38.

The light guiding unit 32 emits light input from the light source toward the liquid-crystal display panel PNL. The prism sheet 34 and diffusion sheet 36 are optical sheets arranged between the liquid-crystal display panel PNL and the light guiding unit 32. The reflection sheet 38 is arranges so as to face the principal surface of the light guiding unit 32 opposite the liquid-crystal display panel PNL. The prism sheet 34 and diffusion sheet 36 gather and diffuse rays of light emitted from the light guiding unit 32.

The protective glass PGL protects the display module DYP of the liquid-crystal display panel PNL from an external shock. The protective glass PGL may be omitted.

Next, the display device of FIG. 1 will be explained in detail.

The liquid-crystal display panel PNL is configured to sandwich a liquid-crystal layer LQ between the array substrate 10 and an opposite substrate 20, which form a pair of electrode substrates. The transmissivity of the liquid-crystal display panel PNL is controlled by a liquid-crystal driving voltage applied to the liquid-crystal layer LQ from a pixel electrode PE provided on the array substrate 10 and a common electrode CE provided on the opposite substrate 20.

In the array substrate 10, a plurality of pixel electrodes PE are arranged in almost a matrix on a transparent insulating substrate (not shown). A plurality of gate lines GLs are arranged along a plurality of rows of pixel electrodes PEs and a plurality of signal lines SLs are arranged along a plurality of columns of pixel electrodes PEs.

Each pixel electrodes PE and the common electrode CE are made of transparent electrode material, such as indium tin oxide (ITO), and each are covered with an alignment film AL. The pixel electrode PE and common electrode CE, together with a pixel region, a part of the liquid-crystal layer LQ, constitute a liquid-crystal pixel PX.

Near a position where a gate line GL and a signal line cross, a plurality of pixel switches SWPs are arranged. Each pixel switch SWP is, for example, a thin-film transistor (TFT). In the pixel switch, the gate is connected to a gate line GL and the source-drain path is connected between a signal line SL and a pixel electrode PE. When the pixel switch has been driven via the corresponding gate line GL, the path conducts between the corresponding signal line SL and the corresponding pixel electrode PE.

In addition, the array substrate 10 is provided with a sensor circuit 12. A coupling pulse line CPL, a precharge gate line PG, and a read gate line RG are arranged along each row of pixel electrodes PEs.

In the embodiment, the signal line SL is also used as a precharge line PRL for supplying a signal for driving the sensor circuit 12 and a read line ROL. A detailed operation of this will be described later.

The scanning line driving circuit YD supplies gate voltages for turning on pixel switches SWP (to cause the source-drain path to conduct) to the gate lines GLs, thereby driving the gate lines GLs sequentially. In addition, the scanning line driving circuit YD drives a plurality of coupling pulse line CPLs, a plurality of precharge gate lines PGs, and a plurality of read gate lines RGs with specific timing, thereby driving the sensor circuit 12.

The signal line driving circuit XD supplies a video signal from a signal line SL to a pixel electrode PE via a pixel switch SWP whose source-drain path has conducted.

The circuit board 60 includes a multiplexer MUX, a digital-to-analog conversion module DAC, an analog-to-digital conversion module ADC, an interface module IF, and a timing controller TCON.

The timing controller CONT controls the operations of various modules mounted on the circuit board 60 and the operations of the scanning line driving circuit YD, signal line driving circuit XD, common electrode driving circuit, and sensor circuit 12.

A digital video signal taken in from an external signal source SS via an interface module IF is converted into an analog signal by the digital-to-analog conversion module DAC and output to a signal line SL with specific timing by the multiplexer MUX.

The output signal from the sensor circuit 12 is supplied with specific timing from the multiplexer MUX to the analog-to-digital conversion module ADC, converted into a digital signal, and then supplied to the interface module IF. The interface module IF outputs the received digital signal to the control module 65. The control module 65 detects from the received digital signal whether contact has been made and calculates coordinates, thereby detecting a coordinate position where a fingertip, a stylus tip, or the like has touched.

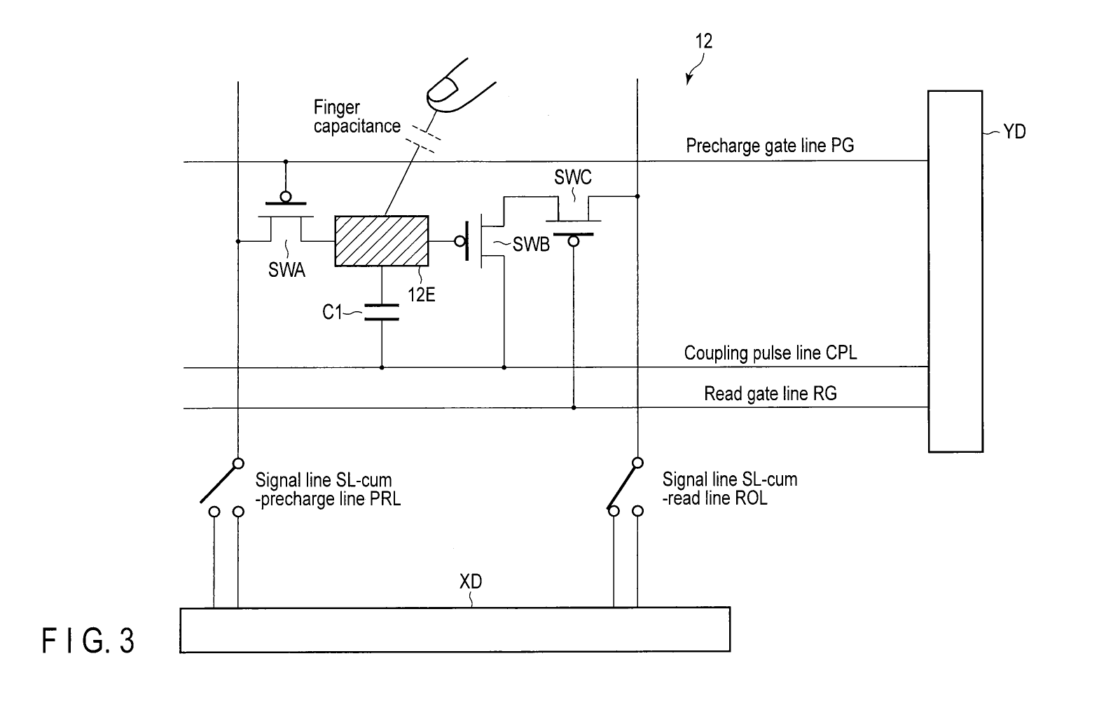

FIG. 3 is an exemplary diagram showing an equivalent circuit of the sensor circuit 12 according to the embodiment.

The sensor circuit 12 includes a detection electrode 12E, a precharge line PRL, a read line ROL, a precharge gate line PG, a coupling pulse line CPL, a read gate line RG, a precharge switch SWA, a coupling capacitance Cl, an amplification switch SWB, and a read switch SWC.

The detection electrode 12E detects a change in the detected capacitance caused by the presence or absence of a contact body. The precharge line PRL supplies a precharge voltage to the detection electrode 12E. The read line ROL takes out a voltage from the detection electrode 12E. The precharge gate line PG, coupling pulse line CPL, and read gate line RG supply signals for driving the sensor circuit 12.

The precharge switch SWA is a switch for writing and holding a precharge voltage in the detection electrode 12E. The coupling capacitance Cl causes the detection electrode 12E to produce a voltage difference according to a change in the detected capacitance. The amplification switch SWB is a switch for amplifying voltage difference produced at the detection electrode 12E. The read switch SWC is a switch for outputting and holding the amplified voltage difference to and in the read line ROL.

The precharge line PRL and read line ROL share interconnections with the signal line SL. Since one unit of the sensor circuit 12 is provided for a plurality of pixels PXs, a part of the signal lines SLs are shared.

The precharge switch SWA is, for example, a p-type thin-film transistor. The precharge switch SWA has its gate electrode electrically connected to the precharge gate line PG (or integrally formed with the precharge gate line PG), its source electrode electrically connected to the precharge line PRL (or integrally formed with the precharge line PRL), and its drain electrode electrically connected to the detection electrode 12E (or integrally formed with the detection electrode 12E).

The amplification switch SWB is, for example, a p-type thin-film transistor. The amplification switch SWB has its gate electrode electrically connected to the detection electrode 12E (or integrally formed with the detection electrode 12E), its source electrode electrically connected to the coupling pulse line CPL (or integrally formed with the coupling pulse line CPL), and its drain electrode electrically connected to the source electrode of the read switch SWC (or integrally formed with the source electrode SWC).

The read switch SWC is, for example, a p-type thin-film transistor. The read switch SWC has its gate electrode electrically connected to the read gate line RG (or integrally formed with the read gate line RG), its source electrode electrically connected to the drain electrode of the amplification switch SWB (or integrally formed with the drain electrode), and its drain electrode electrically connected to the read line ROL (or integrally formed with the read line ROL).

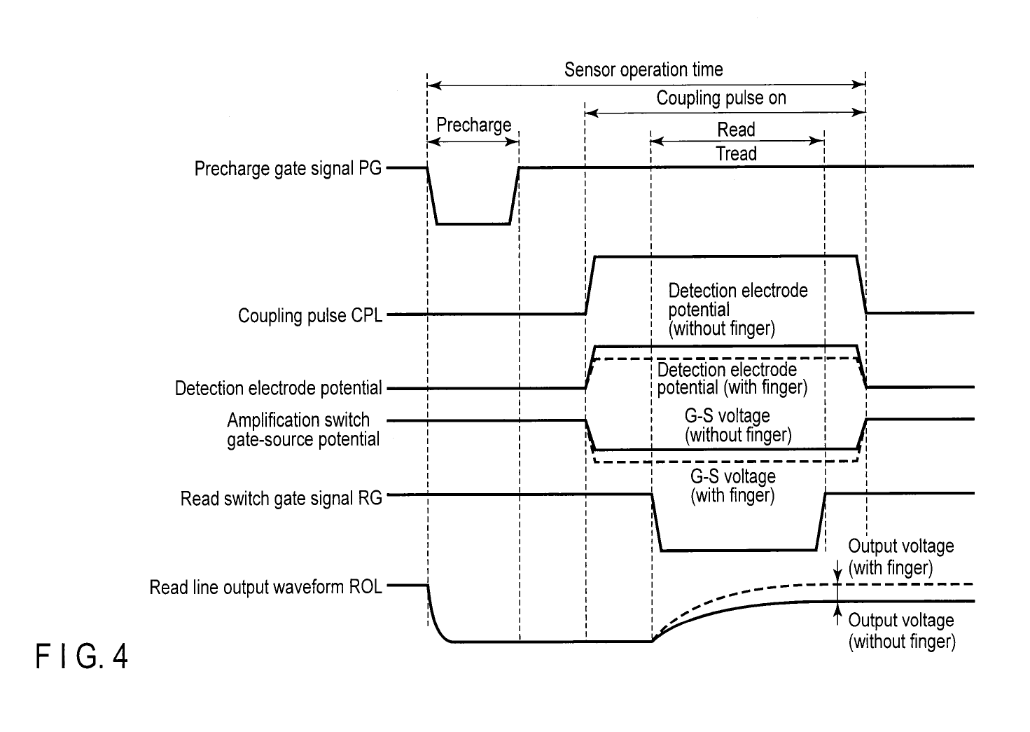

FIG. 4 shows an exemplary timing chart to explain a method of driving the display device 1 according to the embodiment.

A precharge gate line driving waveform (a precharge gate signal waveform) is applied to a precharge gate line PG and input to the gate electrode terminal of a precharge switch SWA. As a result, a precharge voltage Vprc is written from a precharge line PRL into the detection electrode 12E via the precharge switch SWA at the time when a precharge pulse is at an on level (low).

The coupling pulse line driving waveform is applied to a coupling pulse line CPL, thereby varying the potential of the detection electrode 12E via a coupling capacitance Cl according to the presence or absence of a contact body. A detection electrode potential waveform shows a variation in the potential of the detection electrode 12E. A voltage difference can be produced between a detection electrode potential (without a finger) and a detection electrode potential (with a finger).

The gate-source (GS) voltage waveform of the amplification switch SWB shows that a voltage difference produced at the detection electrode 12E is reflected on a difference in the operating point of the amplification switch SWB. A voltage difference is produced between a gate-source (GS) voltage (without a finger) and a gate-source (GS) voltage (with a finger). A read gate line driving waveform is applied to a read gate line RG and input to the gate electrode terminal of the read switch SWC.

As a result, a potential after the fluctuation of a coupling pulse is output to the read line ROL via the amplification switch SWB and read switch SWC at the time when a pulse applied to the read gate line RG is at the on level. A voltage waveform output to the read line ROL shows the voltage variation, producing a voltage difference between an output voltage (with a finger) and an output voltage (without a finger).

To drive the sensor circuit 12, first, the timing controller TCON controls the scanning line driving circuit YD so as to bring a voltage applied to the precharge gate line PG into a low (L) level, thereby turning on the precharge switch SWA. The timing controller TCON controls the signal line driving circuit XD so as to apply a precharge voltage to the precharge line PRL, thereby applying a precharge voltage to the detection electrode 12E via the switch SWA.

Next, the timing controller TCON turns off the precharge switch SWA and then controls the scanning line driving circuit YD to make the coupling pulse line CPL high (H). When the coupling pulse has gone high, the coupling capacitance Cl superposes a voltage on the potential of the detection electrode 12E. At this time, the magnitude of the voltage superposed on the detection electrode 12E depends on the capacitance between the detection electrode 12E and the contact body.

For example, when a finger, a stylus tip, or the like is in contact with the opposite substrate 20 above the detection electrode 12E, a capacitance is produced between the detection electrode 12E and the finger. When a finger, a stylus tip, or the like is in contact with the opposite substrate 20 above the detection electrode 12E, the magnitude of the voltage superposed on the detection electrode 12E becomes smaller than when there is neither a finger nor a stylus tip above the detection electrode 12E.

The on resistance of the amplification switch SWB differs according to the potential of the detection electrode 12E. In the embodiment, when a finger, a stylus tip, or the like is in contact with the opposite substrate 20 above the detection electrode 12E, the on resistance of the amplification switch SWB decreases. When a finger, a stylus tip, or the like is not in contact with the opposite substrate 20 above the detection electrode 12E, the on resistance of the amplification switch SWB becomes relatively high.

Next, the timing controller TCON controls the scanning line driving circuit DY to make the voltage of the read gate line RG low, thereby turning on the read switch SWC. When a finger, a stylus tip, or the like is in contact with the opposite substrate 20 above the detection electrode 12E, if the read switch SWC goes on, a coupling pulse will be supplied to the read line ROL via the amplification switch SWB and read switch SWC.

Therefore, when a finger, a stylus tip, or the like is in contact with the opposite substrate 20, the potential of the read line ROL changes toward the coupling pulse potential. When a finger, a stylus tip, or the like is not in contact with the opposite substrate 20, a change in the potential of the read line ROL becomes smaller than when a finger, a stylus tip, or the like is in contact with the opposite substrate 20.

Accordingly, the position where a finger, a stylus tip, or the like is in contact with the opposite substrate 20 can be detected by detecting the output voltage difference between an output voltage (with a finger) and an output voltage (without a finger) after an output period Tread has elapsed since the read gate line PG was turned on.

FIG. 5 is an exemplary diagram to explain the basic idea of a contact determination method in the display device according to the embodiment.

A vertical axis in FIG. 5 indicates voltage and a horizontal axis indicates frame numbers to be displayed. A position where number (n) is written indicates the time when the n-th frame is completed (or an (n+1)-th frame starts). A thick solid line indicates the threshold of a sensor output value for determining whether a finger or the like has touched the display module DYP. A white circle represents a sensor output value determined to be noncontact. A black circle represents a sensor output value determined to be contact.

A contact determination operation will be explained with reference to FIG. 5. In a first frame, an initial value is used as a threshold value. In a sensor operation period after a display operation period of the first frame, a sensor output value is read from the sensor circuit 12. At this time, since the sensor output value is lower than the threshold value, it is determined to be noncontact and represented as a white circle. In addition, a value obtained by adding a specific value (a) to the sensor output value is used as the threshold value of a second frame. Then, in a sensor operation period after a display operation period of the second frame, too, since the sensor output value is lower than the threshold value, it is determined to be noncontact and represented as a white circle. A value obtained by adding the specific value (a) to the sensor output value is used as the threshold value of a third frame.

In a sensor operation period after a display operation period of the third frame, a sensor output value is read from the sensor circuit 12. At this time, since the sensor output value is higher than the threshold value, it is determined to be in contact and represented as a black circle. When the sensor output value has been determined to be contact, the threshold value is kept at the present value and remains unchanged. Then, in a sensor operation period after a display operation period of a fourth frame, too, since the sensor output value is higher than the threshold value, it is determined to be contact and represented as a black circle. The threshold value is kept at the present value and remains unchanged.

In a sensor operation period after a display operation period of a fifth frame, a sensor output value is read from the sensor circuit 12. At this time, since the sensor output value is lower than the threshold value, it is determined to be noncontact and represented as a white circle. In addition, a value obtained by adding the specific value (α) to the sensor output value is used as the threshold value of a sixth frame. Then, in a sensor operation period after a display operation period of the sixth frame, too, since the sensor output value is lower than the threshold value, it is determined to be noncontact and represented as a white circle. A value obtained by adding the specific value (α) to the sensor output value is used as the threshold value of a seventh frame.

As explained above, a sensor output is measured on a frame basis. A voltage obtained by adding a specific voltage to the sensor output measured one frame before is used as the threshold value for updating. When the threshold voltage has been exceeded, it is determined that the sensor output has shown contact and the threshold value is kept at the value before the contact determination was made. When the sensor output is equal to or lower than the threshold voltage, it is determined that the sensor output has shown noncontact and the threshold value is updated.

The reason why the threshold value is changed dynamically in this way is to prevent an erroneous operation due to a fluctuation in the sensor output caused by display noise or the like. The sensor output varies due to not only short-term display noise but also the influence of long-term temperature around the display device, incident light, or the like.

In a liquid-crystal display device, a pixel voltage supplied to the pixel electrode PE is set with reference to the potential of the common electrode CE. To avoid the deterioration of a liquid-crystal display panel PNL due to eccentrically-located liquid-crystal molecules, the polarity of the pixel voltage is inverted periodically with respect to the potential of the common electrode CE. This driving method is called alternating-current driving. In the embodiment, the timing controller TCONT controls the alternating-current driving.

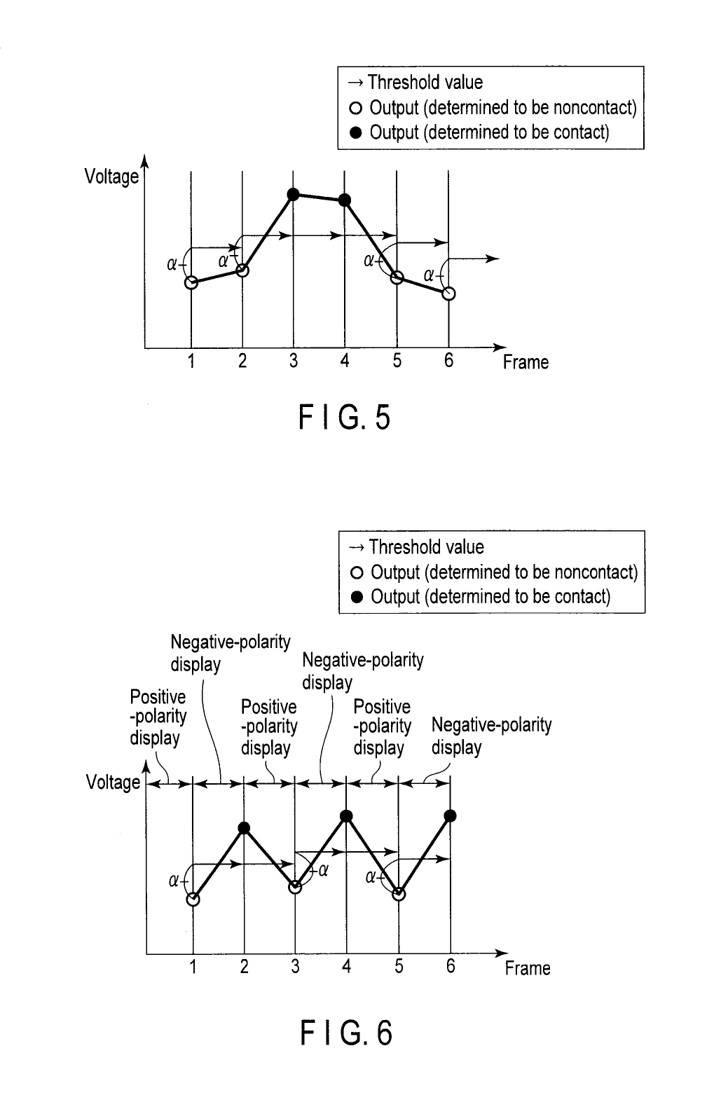

FIG. 6 is an exemplary diagram to explain points to keep in mind when the contact determination method in the display device according to the embodiment is applied to an alternating-current-driven liquid-crystal device. FIG. 6 shows a contact determination state when only alternating-current driving has been performed with the contact state remaining unchanged.

In a first frame, an initial value is used as a threshold value. In a sensor operation period after a display operation period of the first frame, a sensor output value is read from the sensor circuit 12. At this time, since the sensor output value is lower than the threshold value, it is determined to be noncontact and represented as a white circle. In addition, a value obtained by adding a specific value (α) to the sensor output value is used as the threshold value of a second frame.

In a sensor operation period after a display operation period of the second frame, a sensor output value is read from the sensor circuit 12. At this time, since the sensor output value is higher than the threshold value, it is determined to be contact and represented as a black circle. However, in the first and second frames, the contact state has remained unchanged and the display polarity has been changed only from a positive polarity display to a negative polarity display.

The same states as in the first and second frames take place also in a third and a fourth frame and in a fifth and a sixth frame.

Since the sensor output has fluctuated under the influence of the inversion of the display polarity on a frame basis and its variation has exceeded the threshold voltage, it is conceivable that a contact determination is made even in a noncontact state (conversely, a noncontact determination is made in a contact state).

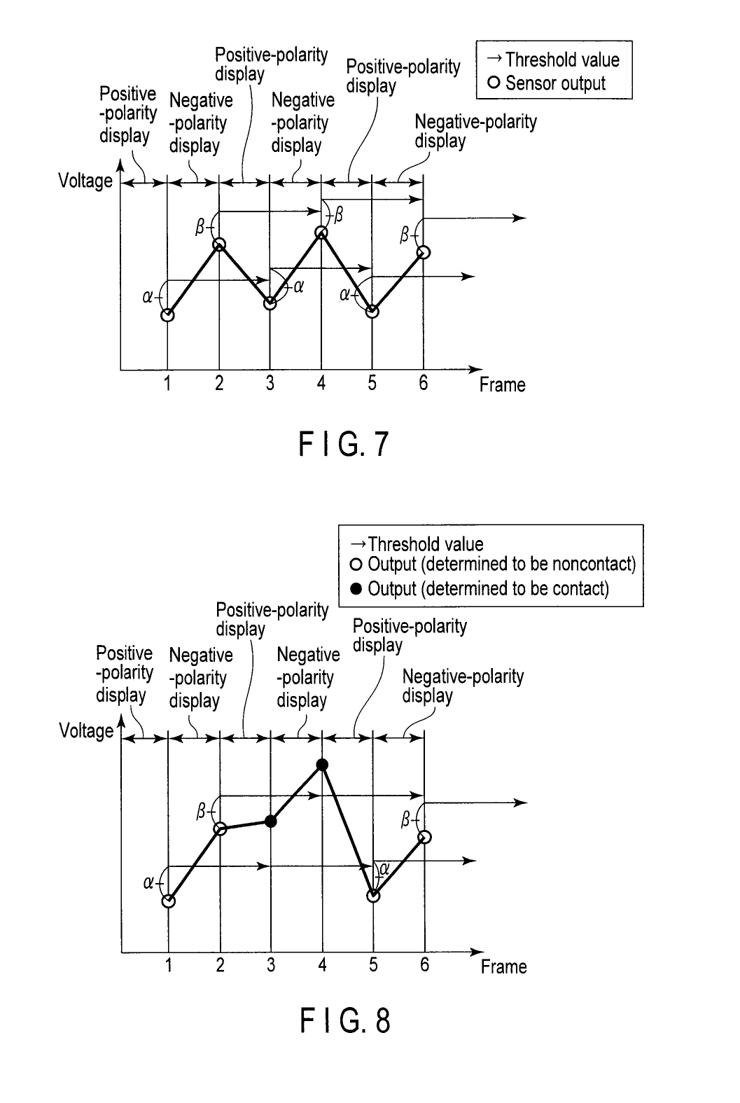

FIG. 7 is an exemplary diagram to explain a contact determination method in alternating-current driving in the display device according to the embodiment. In alternating-current driving, a threshold value for a sensor output after a positive polarity display and a threshold value for a sensor output after a negative polarity display are given separately. The same values as those in FIG. 6 are used as the sensor output values in FIG. 7 for comparison.

In a positive-polarity-display first frame, an initial value of a positive-polarity-display threshold value is used as a threshold value. In a sensor operation period after a display operation period of the positive-polarity-display first frame, a sensor output value is read from the sensor circuit 12. At this time, since the sensor output value is lower than the threshold value, it is determined to be noncontact and represented as a white circle. In addition, a value obtained by adding a positive-polarity specific value (α) to the sensor output value is used as the threshold value of a positive-polarity-display third frame.

In a negative-polarity-display second frame, an initial value of a negative-polarity-display threshold value is used as a threshold value. In a sensor operation period after a display operation period of the negative-polarity-display second frame, a sensor output value is read from the sensor circuit 12. At this time, since the sensor output value is lower than the threshold value, it is determined to be noncontact and represented as a white circle. In addition, a value obtained by adding a negative-polarity specific value (β) to the sensor output value is used as the threshold value of a negative-polarity-display fourth frame.

From this point on, the sensor output is read and the threshold value is changed dynamically on an odd-numbered frame basis for the positive polarity and on an even-numbered frame basis for the negative polarity. This prevents an erroneous operation from occurring in alternating-current driving.

FIG. 8 is an exemplary diagram to explain a contact determination in alternating-current driving in the display device according to the embodiment.

The operations of a positive-polarity display first frame and a negative-polarity display second frame are the same as those in FIG. 7 and therefore a detailed explanation of them will be omitted.

In a sensor operation period after a display operation period of a positive-polarity-display third frame, a sensor output value is read from the sensor circuit 12. At this time, since the sensor output value is higher than the threshold value, it is determined to be contact and represented as a black circle. Then, the threshold value used in the positive-polarity-display third frame is further used as the threshold value of a positive-polarity-display fifth frame.

In a sensor operation period after a display operation period of a negative-polarity-display fourth frame, a sensor output value is read from the sensor circuit 12. At this time, since the sensor output value is higher than the threshold value, it is determined to be contact and represented as a black circle. Then, the threshold value used in the positive-polarity-display fourth frame is used as the threshold value of a positive-polarity-display sixth frame.

The operations of the positive-polarity-display fifth frame and the negative-polarity-display sixth frame are the same as those in FIG. 7 and therefore a detained explanation of them will be omitted.

Next, the configuration of the control module 65 to realize the above operations and the processing procedure will be explained.

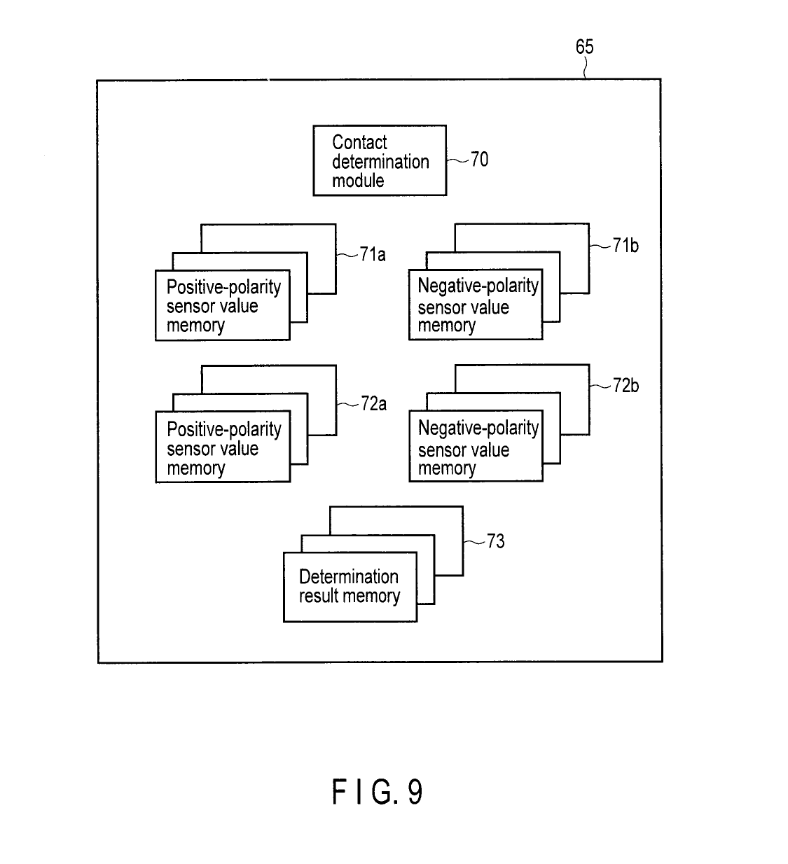

FIG. 9 is an exemplary block diagram showing a configuration related to a contact determination process of the control module 65 according to the embodiment. The control module 65 includes a contact determination module 70, a positive-polarity sensor value memory 71a, a negative-polarity sensor value memory 71b, a positive-polarity threshold value memory 72a, a negative-polarity threshold value memory 72b, and a determination result memory 73.

The contact determination module 70 determines from an output value of the sensor circuit 12 whether contact has been made and outputs the result to the determination result memory 73. The determination result memory 73 has stored as many determination results (concerning the presence or absence of contact) at the contact determination module 70 as equal a specific number of past frames.

In the positive-polarity sensor value memory 71a, sensor output values read during the positive-polarity display are stored on a frame basis. The positive-polarity sensor value memory 71a has stored as many sensor output values as equal a specific number of past frames. In the negative-polarity sensor value memory 71b, sensor output values read during the negative-polarity display are stored on a frame basis. The negative-polarity sensor value memory 71b has stored as many sensor output values as equal a specific number of past frames.

In the positive-polarity threshold value memory 72a, threshold values to be applied to sensor output values read during the positive-polarity display are stored on a frame basis. The positive-polarity threshold value memory 72a has stored as many threshold values as equal a specific number of past frames. In the negative-polarity threshold value memory 72b, threshold values to be applied to sensor output values read during the negative-polarity display are stored on a frame basis. The negative-polarity threshold value memory 72b has stored as many threshold values as equal a specific number of past frames.

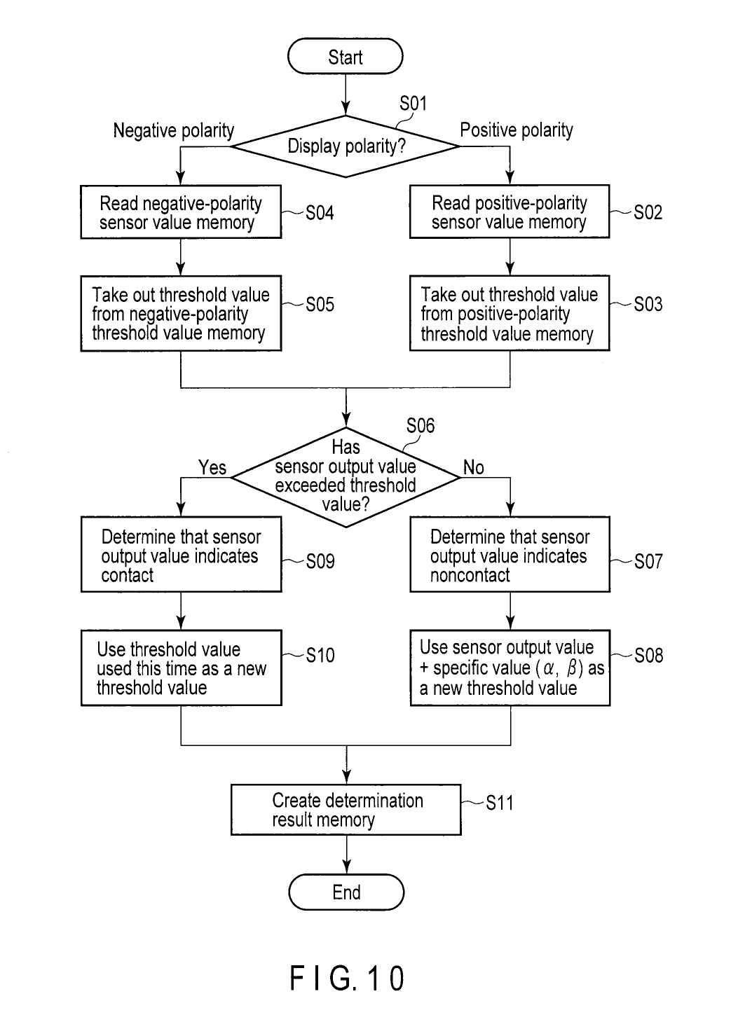

FIG. 10 shows an exemplary flowchart to explain a schematic procedure for a contact presence/absence determination process according to the embodiment. As described above, an output signal from the sensor circuit 12 is input to the control module 65 via the multiplexer MUX, analog-to-digital conversion module ADC, and interface module IF.

The control module 65 writes a signal obtained by an input processing module (not shown) into the positive-polarity sensor value memory 71a or negative-polarity sensor value memory 71b on a frame basis. Then, the contact determination module 70 performs a contact presence/absence determination process.

In step S01, the contact determination module 70 checks whether the display polarity when a sensor value was input corresponds to either positive-polarity display or negative-polarity display.

If the result in step S01 has shown that the display polarity corresponds to positive-polarity display, the contact determination module 70 reads the latest positive-polarity sensor value memory 71a in step S02. In the positive-polarity sensor value memory 71a, a sensor value from each sensor circuit 12 has been stored. In step S03, the contact determination module 70 reads the corresponding positive-polarity threshold value memory 72a. In this positive-polarity threshold value memory 72a, for example, the threshold value two frames before has been stored.

The result in step S01 has shown that the display polarity corresponds to negative-polarity display, the contact determination module 70 reads the latest negative-polarity sensor value memory 71b in step S04. In the positive-polarity sensor value memory 71b, a sensor value from each sensor circuit 12 has been stored. In step S05, the contact determination module 70 reads the corresponding negative-polarity threshold value memory 72b. In this negative-polarity threshold value memory 72b, for example, the threshold value two frames before has been stored.

The contact determination module 70 repeats the processes described below for each sensor circuit 12.

In step S06, the contact determination module 70 checks whether the sensor value has exceeded the threshold value.

If the sensor value has not exceeded the threshold value (NO in step S06), the contact determination module 70 determines that the sensor value indicates noncontact. In step S08, the contact determination module 70 sets a value obtained by adding a specific value (α in the case of positive polarity and β in the case of negative polarity) to the sensor value as a new threshold value and creates a positive-polarity threshold value memory 72a or a negative-polarity threshold value memory 72b. Then, in step S11, the contact determination module writes the determination result (noncontact) about the sensor value into the determination result memory 73.

If the sensor value has exceeded the threshold value (YES in step S06), the contact determination module 70 determines that the sensor value indicates contact in step S09. In step S10, the contact determination module 70 sets the threshold value used this time as a new threshold value and creates a positive-polarity threshold value memory 72a or a negative-polarity threshold value memory 72b. Then, in step S11, the contact determination module writes the determination result (contact) about the sensor value into the determination result memory 73.

A coordinate position detection module (not shown) provided on the control module 65 calculates coordinates using the determination results stored in the determination result memory 73, thereby detecting the coordinate position where a fingertip, a stylus tip, or the like makes contact.

By the above processes, the influence of display noise or the like can be reduced and the contact position detection accuracy be improved.

[Variations of the Embodiment]

The embodiment can be configured in the form of various variations.

(1) While in the embodiment, the sensor has operated on a frame basis, it goes without saying that the embodiment is effective also in a case where the sensor operates in units of M (an arbitrary number in the range of 1 to the maximum row number) rows.

In addition, of course, the embodiment is effective also in a case where the sensor operates in units of several frames.

(2) While in the embodiment, a threshold value is provided for each sensor circuit, a threshold value may be provided for each group by organizing adjacent sensor circuits into groups. At this time, a contact determination is made on each group of sensor circuits. A value obtained by processing (for example, averaging) the output values of sensor circuits subjected to a contact determination is used as a sensor output value.

(3) In the embodiment, a threshold value used in a contact determination has been calculated on the basis of the sensor output value. The sensor output value used in the calculation is not limited to the current value. A specific number of past sensor output values may be used. For example, a value obtained by subjecting a specific number of past sensor output values including the current one to an average process (for example, simple average or moving average) may be used. A long-term influence of temperatures around the display device, incident light, or the like can be reduced.

(4) The display device 1 of the embodiment may be a liquid-crystal display device that employs a twisted nematic (TN) mode, an IPS mode, an optically compensated bend (OCB) mode, or the like as a display mode.

(5) The display device of the embodiment may be applied to a color display device and a black-and-white display device.

(6) The sensor circuit 12 may have the read switch SWC and read gate line RG eliminated. In that case, the drain electrode of the amplification switch SWB is electrically connected to the read line ROL.

(7) A coupling pulse may not be supplied from the gate line GL. For instance, an interconnection in parallel with the signal line SL may be added and used as a coupling pulse line.

(8) The timing controller TCON is not necessarily provided on the circuit board 60 and may be provided outside the circuit board or on a TFT board.

(9) The amplification switch SWB is not limited to the embodiment. It may be configured using an amplifier.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a plurality of pixel circuits which are arranged in a matrix;
a plurality of sensor circuits which are arranged in regions between the pixel circuits and which read the magnitude of capacitance coupling;
a plurality of scanning lines for the pixel circuits and sensor circuits which are extended in a row direction in which the pixel circuits are arranged;
a plurality of signal lines for the pixel circuits and sensor circuits which are extended in a column direction in which the pixel circuits are arranged and a part of which are shared;
a display driver which drives a plurality of scanning lines and signal lines for the pixel circuits in a display operation period and writes a display signal into the pixel circuits on a row basis;
a sensor driver which drives a plurality of scanning lines and signal lines for the sensor circuits in a sensor operation period and reads a signal representing the magnitude of the capacitance coupling from the sensor circuits on a row basis;
a controller which controls alternating-current driving that inverts, with a specific period, the polarity of a display signal written into the pixel circuits; and
a determination module which determines a magnitude correlation between a sensor signal read from the sensor circuit and a polarity-based threshold value corresponding to the polarity of alternating-current driving in reading the sensor signal.

2. The display device of claim 1, wherein the determination module uses a polarity-based threshold value as a new threshold value in a next determination when the sensor signal is larger than the polarity-based threshold value, and
uses a value obtained by adding a specific value corresponding to the polarity to the sensor signal as a new polarity-based threshold value in a next determination when the sensor signal is equal to or smaller than the polarity-based threshold value.

3. The display device of claim 2, wherein the polarity-based threshold value is provided for each of the sensor circuits.

4. The display device of claim 2, wherein the polarity-based threshold value is provided for each group including a plurality of sensor circuits, and
the determination module determines a magnitude correlation between a sensor signal obtained by processing the sensor signals from a plurality of sensor circuits in the group and the polarity-based threshold value.

5. The display device of claim 1, wherein the determination module uses a polarity-based threshold value as a new threshold value in a next determination when the sensor signal is larger than the polarity-based threshold value, and
finds a calculated value obtained by adding a specific value corresponding to the polarity to the sensor signal and uses a value obtained by averaging a specific number of past calculated values as a new polarity-based threshold value in a next determination when the sensor signal is equal to or smaller than the polarity-based threshold value.
